(19) United States
(12) Patent Application Publication
(10) Pub. No.: US 2019/0213584 A1
(43) Pub. Date: Jul. 11, 2019

(54) METHOD AND SYSTEM FOR TOKENIZED REPLACEMENT OF CRYPTO CURRENCY ADDRESSES

(71) Applicant: Mastercard International Incorporated, Purchase, NY (US)

(72) Inventor: Saravana Perumal SHANMUGAM, Fremont, CA (US)

(73) Assignee: Mastercard International Incorporated, Purchase, NY (US)

(21) Appl. No.: 15/868,314

(22) Filed: Jan. 11, 2018

(51) Int. Cl. G06Q 20/38; H04L 9/30; G06Q 20/36; H04L 9/32; G06F 21/64; H04L 9/08

(52) U.S. Cl. CPC G06Q 20/381; H04L 9/30; G06Q 20/367; H04L 2209/56; G06F 21/64; H04L 9/08; H04L 2209/38; H04L 9/3247

(57) ABSTRACT

A method for tokenized cross-currency transacting includes: receiving a transaction request, the request including a source address, destination address, source currency, destination currency, and currency amount; generating an intermediate address associated with a transaction account issued in the source or destination currency; processing a first payment transaction for payment of the currency amount from a transaction account associated with the source address to the transaction account associated with the intermediate address; processing a second payment transaction for payment of the currency amount from the transaction account associated with the intermediate address to a transaction account associated with the destination address; storing a transaction record including at least the intermediate address, source currency, destination currency, the currency amount; and transmitting a notification in response to the received transaction request indicating completion of the second payment transaction.

### FIELD

The present disclosure relates to the use of tokenization to improve cross-currency transactions, specifically the use of tokenization and mapping to enable a first currency to be used to fund a transaction to be paid out to a recipient as a second currency, even in instances where each party may be unable to utilize the other party's currency, including in cases where payment or receipt utilizes a cryptographic currency.

### BACKGROUND

Cryptographic currencies, often supported via the use of a Blockchain, have seen wide use in recent years due to a number of advantages associated therewith, such as privacy and decentralization. These currencies, such as Bitcoin and Ethereum, require specialized communications to facilitate usage thereof, similar to traditional fiat currencies where specialized hardware must be utilized by both parties to a transaction, such as payment cards and point of sale devices that are in communication with a payment network. As a result, some parties that wish to fund transactions may not be able to utilize cryptographic currencies, just as some parties that are recipients of a transaction may be unable to receive cryptographic currencies as payment. These limitations may leave some senders and recipients at a disadvantage; the desired currency for payment or receipt may be unavailable, which may lead to a lost opportunity.

Currently, there are no direct solutions for a sender or recipient to be able to facilitate the use of a different currency by the other party to a transaction. Instead, one of the parties may have to find an intermediary that can facilitate the use of both currencies to receive the funds from the sending party in the first currency and transfer funds to the receiving party in the second currency. The use of such third party services requires the processing of additional transactions, which results in additional fees and processing time, on top of any fees that may be charged by the third party, as well as subjecting the transaction to a conversion rate that may be less than favorable due to the third party's advantageous position. In addition, this is a manual process that requires specific actions to be performed by each of the participants, which can sometimes take a significant amount of time and be subject to errors during each step.

Thus, there is a need for a technological solution to enable two parties to a transaction to transact using different currencies, including cryptographic currencies, without requiring manual currency conversion by an intermediary and the initiation of multiple transactions by the involved parties.

### SUMMARY

The present disclosure provides a description of systems and methods for tokenized cross-currency transacting. A payment processor utilizes tokenization to create an intermediate transaction account of an appropriate currency when a cross-currency transaction is requested by a sender in a transaction. The tokenization enables a one-time or limited use transaction account to be created, regardless of the type of currency involved (e.g., fiat or cryptographic currency), that can be mapped to an established transaction account, and yet still used for the cross-currency transaction. This may be suitable even in cases where a sender wants to pay for a transaction using cryptographic currency, which may be unavailable to the receiver, or vice versa, where the intermediate transaction account may be a blockchain wallet for the appropriate cryptographic currency that is created for the single transaction. The use of tokenization not only facilitates faster and simpler cross-currency transacting for all entities involved, requiring the sender and receiver to do nothing more than supply the account information for their respective accounts, it also provides for more accurate and easer record keeping. This may be a drastic improvement in jurisdictions where records must be kept for cross-currency transactions, as the tokenization allows for easy one-to-one tracking of transactions, even in cases where cryptographic currencies are utilized.

A method for tokenized cross-currency transacting includes: receiving, by a receiver of a processing server, a transaction request, wherein the transaction request includes at least a source address, a destination address, a source currency, a destination currency, and currency amount; generating, by the processing server, an intermediate address, wherein the intermediate address is associated with a transaction account issued in one of: the source currency and the destination currency; processing, by the processing server, a first payment transaction for payment of the currency amount from a transaction account associated with the source address to the transaction account associated with the intermediate address, wherein the payment transaction includes conversion of the currency amount to the destination currency from the source currency if the intermediate address is associated with a transaction account issued in the destination currency; processing, by the processing server, a second payment transaction for payment of the currency amount from the transaction account associated with the intermediate address to a transaction account associated with the destination address, wherein the payment transaction includes conversion of the currency amount to the destination currency from the source currency if the intermediate address is associated with a transaction account issued in the source currency; storing, in a memory of the processing server, a transaction record, wherein the transaction record includes at least the intermediate address, the source currency, the destination currency, and the currency amount; and electronically transmitting, by a transmitter of the processing server, a notification in response to the received transaction request, wherein the notification indicates completion of the second payment transaction.

A system for tokenized cross-currency transacting includes: a receiver configured to receive a transaction request, wherein the transaction request includes at least a source address, a destination address, a source currency, a destination currency, and currency amount; a processing server configured to generate an intermediate address, wherein the intermediate address is associated with a transaction account issued in the destination currency, process a first payment transaction for payment of the currency amount from a transaction account associated with the source address to the transaction account associated with the intermediate address, wherein the payment transaction includes conversion of the currency amount to the destination currency from the source currency if the intermediate address is associated with a transaction account issued in the destination currency, and process a second payment transaction for payment of the currency amount from the transaction account associated with the intermediate address to a transaction account associated with the destination address, wherein the payment transaction includes conversion of the currency amount to the destination currency from the source currency if the intermediate address is associated with a transaction account issued in the source currency; a memory of the processing server configured to store a transaction record, wherein the transaction record includes at least the intermediate address, the source currency, the destination currency, and the currency amount; and a transmitter configured to electronically transmit a notification in response to the received transaction request, wherein the notification indicates completion of the second payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the use of tokenization in cross-currency transactions in accordance with exemplary embodiments.

FIG. 2 is a block diagram illustrating the processing server of the system of FIG. 1 for processing tokenized cross-currency transactions in accordance with exemplary embodiments.

FIG. 3 is a flow diagram illustrating a process for performing a cross-currency transaction using tokenization executed by the processing server of FIG. 2 in accordance with exemplary embodiments.

FIG. 4 is a flow chart illustrating an exemplary method for tokenized cross-currency transacting in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Cross-Currency Transacting

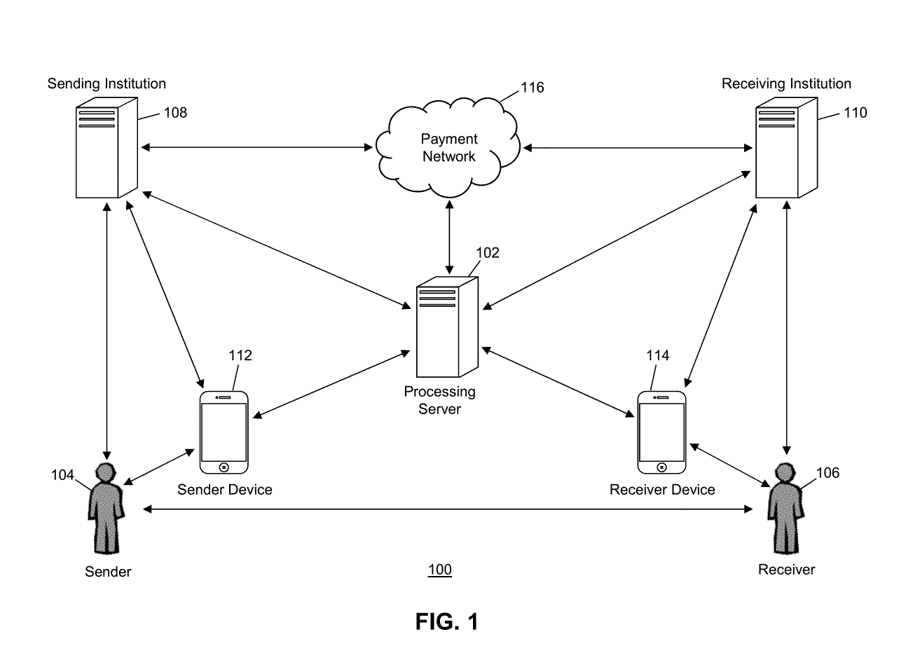

FIG. 1 illustrates a system 100 for the processing of payment transactions utilizing multiple currencies, including the use of cryptographic currencies, facilitated by a centralized processing server and tokenization of transaction accounts.

The system 100 may include a processing server 102. The processing server 102, discussed in more detail below, may be configured to perform processing functions for a cross-currency transaction that includes the use of a tokenization and at least one intermediate transaction account to facilitate the cross-currency conversion and auditing and record keeping of cross-currency transactions. In the system 100, a sender 104 may want to pay a receiver 106 an amount of a first type of currency, where the receiver 106 wants to receive an equivalent amount of a second type of currency. In some cases, the sender 104 and receiver 106 may each be individuals, businesses, or other entities wanting to perform a person-to-person or business-to-business transaction. In other cases, the sender 104 may be a consumer and the receiver 106 a merchant, where the cross-currency transaction may be part of a standard payment transaction for the purchase of goods or services.

The sender 104 may have a transaction account issued thereto by a sending institution 108. The sending institution 108 may be a financial institution, such as an issuing bank, or other entity configured to issue transaction accounts for use in funding electronic payment transactions. The sending institution 108 may issue a transaction account to the sender 104 that is associated with a first currency, also referred to herein as a “source currency.” The receiver 106 may be similarly issued a transaction account by a receiving institution 110, where the transaction account may be issued to the receiver 106 for use in receiving funds in electronic payment transactions. The transaction account issued to the receiver 106 may be of a second currency, also referred to herein as a “destination currency.”

In some embodiments, the source currency and/or the destination currency may be a cryptographic currency. In such embodiments, there may be no single sending institution 108 or receiving institution 110, as applicable. Instead, the sender 104 or receiver 106 may have an electronic wallet that is used to prove ownership of an amount of cryptographic currency by the sender 104 or receiver 106 as applicable, where information regarding the cryptographic currency and amounts associated with each electronic wallet is stored in a blockchain. The blockchain may be a decentralized ledger that is maintained by a plurality of different computing systems, referred to as “nodes,” operating as a blockchain network. In such cases, the sending institution 108 or receiving institution 110 as used herein may refer to one or more nodes in the respective blockchain network, as applicable. In some embodiments, both the sender 104 and receiver 106 may desire to use a cryptographic currency for the cross-currency transaction, where the sender 104 and receiver 106 may each use a different type of cryptographic currency.

The sender 104 may initiate a cross-currency transaction by submitting a transaction request to the processing server 102. The sender 104 may utilize a computing device associated therewith, referred to herein as the sender device 112. The sender device 112 may be any type of computing device suitable for performing the functions discussed herein, such as a desktop computer, laptop computer, notebook computer, tablet computer, cellular phone, smart phone, smart watch, smart television, wearable computing device, implantable computing device, etc. The sender device 112 may communicate with the processing server 102 using any suitable method, such as via a web page, application program, application programming interface (API), short messaging service, multimedia messaging service, e-mail, etc. The transaction request submitted to the processing server 102 may include at least a source address, destination address, source currency, destination currency, and currency amount.

The source address may be an address or other identification information associated with the transaction account to be used by the sender 104 in funding the transaction. In cases where the source transaction account is a fiat currency account, the source address may be the primary account number (e.g., or other payment credentials including the primary account number) associated with the transaction account. In cases where the source transaction account is a cryptographic currency account, the source address may include one or more addresses in the associated blockchain that are associated with cryptographic currency to be transferred as part of the transaction. In such cases, the source address may include or be otherwise accompanied by a digital signature generated by the electronic wallet associated with the sender 104 to prove ownership or other authority to use the cryptographic currency associated with the source address. For example, the sender device 112 may include an electronic wallet for use with a blockchain currency. The electronic wallet may include or may otherwise have access to, either directly in the sender device 112 or externally via the sender device 112, a cryptographic key pair including a public key and corresponding private key. The electronic wallet may use the private key to generate a digital signature that may be verified by other entities (e.g., nodes in the associated blockchain network) using the public key to prove ownership of blockchain addresses in the blockchain network generated using that public key. In these cases, the sender device 112 may generate a digital signature for inclusion in the transaction request using the private key. In cases where the source transaction account is a fiat currency account, the sending institution 108 may provision payment credentials to the sender device 112, which may include them in the transaction request for funding the cross-currency transaction accordingly.

The destination address may be an address or other identification information associated with the transaction account to be used by the receiver 106 to receive funds of the cross-currency transaction. As with the source address, the destination address may be for a transaction account that utilizes a fiat currency, or may utilize a cryptographic currency, which may differ from a cryptographic currency used by the sender 104 to fund the transaction. The source currency and destination currency may each indicate the currency used by the source transaction account and destination transaction account, respectively. The currency amount may be an amount being sent or an amount to be received, which may utilize the respective currency as indicated in the transaction request. For instance, the sender 104 may specify an amount being sent or to be received (e.g., $100), where the processing server 102 may use any suitable method to determine the equivalent amount in the other currency involved in the cross-currency transaction. In some cases, the transaction request may include both the source amount and destination amount, such as in instances where the sender 104 and receiver 106 agree on a conversion rate between the source currency and destination currency.

In some embodiments, the transaction request may only include a portion of the data. For instance, the transaction request may include the source address, source currency, and currency amount, but may not include destination information. In such embodiments, the receiver 106 may use a receiver device 114 to provide the destination address and destination currency to the processing server 102. The receiver device 114 may be a suitable type of computing device, such as with the sender device 112, that the receiver 106 may use to communicate with the processing server 102 using a suitable communication network and method. The receiver 106 may thus provide the processing server 102 with the desired destination currency and a destination address for receipt of the funds from the cross-currency transaction. In such cases, the submission by the receiver 106 may reference the transaction request submitted by the sender 104 (e.g., using a unique identification value or other suitable method). In some instances, the processing server 102 may prompt the receiver 106 via the receiver device 114 for the information, where the transaction request may include contact information (e.g., telephone number, e-mail address, device identifier, username, etc.) for the receiver device 114, such as may be supplied by the sender 104 via the sender device 112.

The processing server 102 may receive the transaction request and may identify at least one intermediate address. The intermediate address may be associated with an intermediate transaction account to be used as an intermediary in the conversion of the first currency into the second currency. In some cases, the intermediate transaction account may be independent of the source transaction account and the destination transaction account. In other cases, the intermediate transaction account may be the source transaction account or the destination transaction account, where the intermediate address may be a one-time or limited-use transaction account number (e.g., or electronic wallet, as applicable) that is mapped to the respective transaction account. In some embodiments, two intermediate addresses may be identified by the processing server 102, one associated with a transaction account using the source currency and the other associated with a transaction account using the destination currency. In other embodiments, a single intermediate address may be used, where the processing of the cross-currency transaction may include processing of a payment transaction involving the intermediate transaction account that utilizes both the source and the destination currency (e.g., processed similar to a cross-border transaction using traditional methods).

The processing server 102 may be configured to identify a suitable number of intermediate addresses (e.g., one or two), which may be associated with the source or destination transaction accounts or additional intermediate transaction accounts, and may utilize currency conversion internally or through cross-border-type payment transactions. The implementation may be based on the source currency and destination currency, configurations of the source and destination transaction accounts, limitations of the sending institution 108 and receiving institution 110, and other criteria as discussed herein.

In a first example, the sender 104 may desire to send an amount of a first fiat currency to the receiver 106 to be received in a second fiat currency. The processing server 102 may generate a controlled payment number associated with a separate, intermediate transaction account, where the controlled payment number is to be used for the single, cross-currency payment transaction. The processing server 102 may initiate a first payment transaction for payment of the currency amount (e.g., or a converted amount, as applicable) from the source transaction account to the intermediate account. The processing server 102 may then initiate a second payment transaction for payment of the currency amount (e.g., or a converted amount, as applicable) from the intermediate transaction account to the destination transaction account. The intermediate transaction account may be in the source currency or the destination currency, where the first or second payment transaction may include conversion of currencies, as applicable. In some cases, the processing server 102 may use two intermediate transaction accounts, one in each currency, where the first payment transaction may use the source currency and the second payment transaction may use the destination currency, where no conversion may take place except through internal record keeping of the processing server 102, if necessary.

In a second example, the sender 104 may desire to send an amount of a first fiat currency to the receiver 106 to be received in a second fiat currency, where the processing server 102 may generate a controlled payment number issued on the source transaction account. In such an example, the processing server 102 may initiate only a single payment transaction, where the payment transaction may be for payment of the currency amount from the source transaction account to the destination account, funded via the controlled payment number, where the currency is converted as part of the processing of the transaction account. In this instance, the controlled payment number may be a number that is suitable for use in a cross-border-type transaction and may be used for a single transaction or otherwise limited in use.

In a third example, the source currency may be a cryptographic currency and the destination currency may be a fiat currency. In such an example, the processing server 102 may identify an intermediate address, which may be a blockchain address generated using a public key of a cryptographic key pair of an electronic wallet that utilizes the source cryptographic currency. In some embodiments, the electronic wallet may be newly generated for use in the cross-currency transaction. In other embodiments, the electronic wallet may be one used by the processing server 102 in the receipt and transfer of funds as part of the system 100. In some cases, the electronic wallet may be generated and associated with the sender 104. Following generation of the intermediate address, the processing server 102 may initiate a blockchain transaction for payment of the currency amount (e.g., or converted amount, as applicable) from the sender's electronic wallet to the intermediate electronic wallet using the associated blockchain. In cases where the electronic wallet is newly generated for use in the cross-currency transaction, the processing server 102 may initiate a second blockchain transaction for payment of the cryptographic currency amount from the intermediate electronic wallet to a secondary electronic wallet, such as may be used by the processing server 102 for use in future blockchain transactions. For instance, the processing server 102 may have a centralized electronic wallet used for holding cryptographic currency for future payments therefrom. Following the blockchain transaction(s), the processing server 102 may initiate a payment transaction for payment of an equivalent amount in the destination currency from a second intermediate transaction account, issued in the destination currency, to the destination transaction account. In some cases, the processing server 102 may generate a controlled payment number issued on the second intermediate transaction account for use in the funding of the payment transaction thereby. In other cases, a primary account number for the second intermediate transaction account may be used.

In a fourth example, the sender 104 may desire to pay for the cross-currency transaction using a fiat currency, while the receiver 106 may want to receive the funds as in a cryptographic currency. In such a case, the processing server 102 may generate an intermediate address associated with a transaction account issued in the fiat currency for payment from the source transaction account thereto in a payment transaction initiated by the processing server 102. In some cases, a controlled payment number may be issued on the source transaction account for use in the payment transaction for payment of the fiat currency amount to the intermediate transaction account. The processing server 102 may then initiate a blockchain transaction for payment of an equivalent cryptographic currency amount from an electronic wallet accessible by the processing server 102 to the receiver's electronic wallet via the associated blockchain network. In some cases, the processing server 102 may generate a new electronic wallet as a second intermediate transaction account for use in the cross-currency transaction. In such a case, the processing server 102 may initiate an intermediate blockchain transaction to fund the new electronic wallet (e.g., from a separate electronic wallet accessible by the processing server 102, such as for a centralized cryptographic currency account) with a suitable cryptographic currency amount to cover the blockchain transaction to the destination transaction account.

In a fifth example, the sender 104 may desire to pay for the cross-currency transaction using a first cryptographic currency for receipt by the receiver 106 in a second cryptographic currency. In such a case, the processing server 102 may identify a first intermediate address (e.g., blockchain address) for the first cryptographic currency and a second intermediate address (e.g., blockchain address) for the second cryptographic currency. The processing server 102 may initiate a first blockchain transaction for payment from the sender's electronic wallet to an electronic wallet of the first intermediate address (e.g., which may then be sent to a secondary electronic wallet of the first cryptographic currency as a holding account, as applicable). The processing server 102 may then initiate a second blockchain transaction for payment from the electronic wallet of the second intermediate address (e.g., funded via a separate blockchain transaction from a secondary electronic wallet of the second cryptographic currency accessible by the processing server 102) to the receiver's electronic wallet.

In the system 100, payment transactions that are conducted using a fiat currency may be processed via a payment network 116 using suitable methods and systems. The processing server 102 may submit an authorization request to the payment network 116 for the payment transaction, where the authorization request is a specialized type of transaction message, such as may include a message type indicator indicating accordingly. Transaction messages may be specially formatted data messages that are formatted according to standards governing the exchange of financial transaction messages, such as the International Organization of Standardization's ISO 8583 or ISO 20022 standards, which are transmitted via specialized infrastructure of payment networks 116, referred to herein as payment rails. In some cases, the processing server 102 may be a part of a payment network 116. The authorization request may be submitted to the payment network 116 that includes a source address or destination address as the funding source or receiving transaction account for the payment transaction, as applicable. The payment network 116 may process the payment transaction using traditional methods and systems, which may include forwarding the authorization request to the sending institution 108 or receiving institution 110, as applicable, for authorization thereof.

Blockchain transactions initiated by the processing server 102 may be processed by one or more nodes in the associated blockchain network. In some embodiments, the payment network 116 may operate as or include a node. In some instances, the processing server 102 may be a node in one or more blockchain networks and may process blockchain transactions directly. Blockchain transactions may be processed by a node in the blockchain network validating the digital signature generated by the funding electronic wallet, verifying that the provided source address(es) is associated with a sufficient amount of cryptographic currency, and adding at least one new entry to the blockchain indicating transfer of the cryptographic currency from the source address(es) to the destination address generated by the public key of the receiving electronic wallet. New entries may be included in a new block generated by the node that is then validated by other nodes in the blockchain network prior to addition to the blockchain using suitable methods and systems. In some cases, the processing server 102 may verify a new entry into the blockchain to ensure that a transfer of funds of the cryptographic currency was processed accurately and correctly, such as by verifying the involved addresses and cryptographic currency amount.

In some embodiments, the processing server 102 may utilize tokenization in the identification of intermediate addresses used in performing the functions discussed herein. In such embodiments, an intermediate address may be a digital token generated or otherwise identified by the processing server 102, where the token may be a one-time use or limited-use digital token that may be used in a payment transaction in place of traditional payment credentials. In some such embodiments, the digital token may be mapped to a transaction account, such as the source transaction account, destination transaction account, or an intermediate transaction account. In some instances, a digital token may be used in place of a controlled payment number or other transaction account number that is limited in usage. In other instances, a digital token may be mapped to a controlled payment number identified for a transaction account to provide for additional security and auditability.

The processing server 102 may be configured to store transaction records for cross-currency transactions and/or for the payment transactions and blockchain transactions initiated by the processing server 102 as part of the processing of cross-currency transactions in the system 100. Each transaction record may include the addresses for the accounts used to send or received funds (e.g., fiat or cryptographic, as applicable) as part of a transaction as well as the amount transferred and any other additional data associated therewith (e.g., transaction time, transaction date, digital signatures, blockchain addresses, etc.). In some cases, a transaction record may include a record for the cross-currency transaction and for any payment transactions and blockchain transactions processed as part of the cross-currency transaction. The use of intermediate addresses may provide for stronger and more accurate record keeping, particularly in instances where cryptographic currencies are involved. In some embodiments, the processing server 102 may be required to comply with rules or regulations in cases where multiple currencies are involved in an electronic transaction, such as may be set by a governmental or other regulatory agency. In such embodiments, the processing server 102 may store and maintain transaction records that are in compliance with such rules or regulations. The use of intermediate address may provide for stronger compliance, such as in cryptographic currency transactions where the source or destination electronic wallet may be unidentifiable due to the anonymous nature of blockchain transactions, which may be mitigated due to intermediate electronic wallets being used for single transactions.

The methods and systems discussed herein thus enable the processing server 102 to facilitate cross-currency transactions for senders 104 and receivers 106 that require minimal participation by each of the entities involved and do not require any modification to sending institutions 108 or receiving institutions 110. As a result, the processing server 102 can perform cross-currency transactions faster and more easily than in traditional methods and systems, with greater convenience to senders 104 and receivers 106. In addition, the use of intermediate transaction accounts, including for blockchain accounts, provides for capabilities enabling cross-currency transactions to be conducted regardless of the type of currency (e.g., fiat or cryptographic) including transactions utilizing multiple types of cryptographic currencies. Furthermore, the intermediate addresses used herein provide for more accurate and useful accounting that can serve for stronger record keeping and provide greater assistance in auditing and compliance with rules or regulations. In some instances, it may be impossible for traditional systems to perform cross-currency transactions involving cryptographic currency due to anonymization involved in the cryptographic currency, which may be mitigated by the use of intermediate addresses discussed herein. In these instances, the processing server 102 may provide a technological solution that solves this problem that is inherent in traditional cross-currency processing methods.

### Processing Server

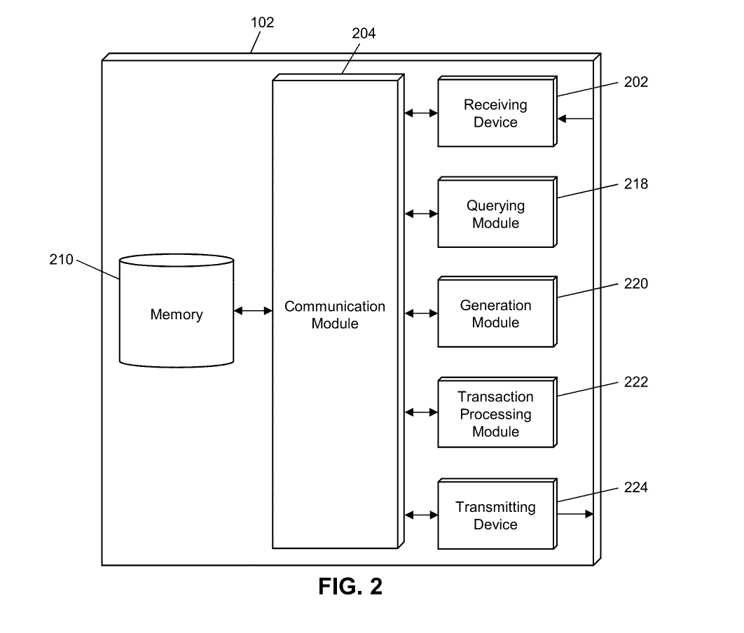

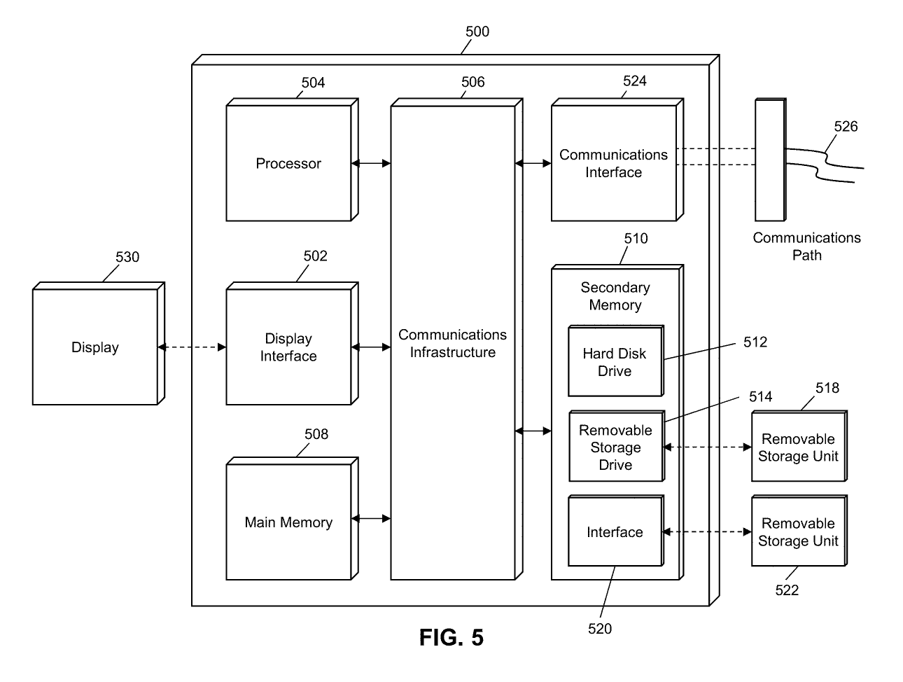

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from sending institutions 108, receiving institutions 110, sender devices 112, receiver devices 114, payment networks 116, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by sending institutions 108 and receiving institutions 110, which may be superimposed or otherwise encoded with controlled payment numbers, digital tokens, addresses, or other data associated with transaction accounts associated with the respective institution, or may be superimposed or otherwise encoded with authorization responses in cases where the processing server 102 may process payment transactions directly and submit authorization requests thereto. The receiving device 202 may be configured to receive data signals electronically transmitted by sender devices 112 and receiver devices 114 that may be superimposed or otherwise encoded with transaction requests or data for inclusion therein. The receiving device 202 may also be configured to receive data signals electronically transmitted by payment networks 116, which may be superimposed or otherwise encoded with authorization responses for payment transactions, blockchain data for blockchain transactions, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include a memory 210. The memory 210 may be configured to store data for use by the processing server 102 in performing the functions discussed herein, such as public and private keys, symmetric keys, etc. The memory 210 may be configured to store data using suitable data formatting methods and schema and may be any suitable type of memory, such as read-only memory, random access memory, etc. The memory 210 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 210 may be comprised of or may otherwise include a relational database that utilizes structured query language for the storage, identification, modifying, updating, accessing, etc. of structured data sets stored therein.

The memory 210 may be configured to store, for example, transaction records for processed cross-currency transactions, such as may include received transaction requests, data for related processed payment transactions and/or blockchain transactions, and other data that may be related to the cross-currency transaction, including data that may be required for auditing and/or compliance with applicable rules or regulations. The memory 210 may also be configured to store intermediate addresses for intermediate transaction accounts as well as any other data associated therewith that may be used in the processing of transactions involving intermediate transaction accounts, such as a cryptographic key pair for a cryptographic currency account, algorithms for use in generating digital signatures, account credentials for holding accounts for various currencies, etc. In cases where digital tokens or controlled payment numbers may be used, the memory 210 may be configured to store mapping data for mapping of the respective data to a corresponding transaction account.

The processing server 102 may include a querying module 218. The querying module 218 may be configured to execute queries on databases to identify information. The querying module 218 may receive one or more data values or query strings, and may execute a query string based thereon on an indicated database, such as the memory 210, to identify information stored therein. The querying module 218 may then output the identified information to an appropriate engine or module of the processing server 102 as necessary. The querying module 218 may, for example, execute a query on the memory 210 to identify an intermediate address associated with a transaction account of a specific currency for use in a cross-currency transaction.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to sender devices 112 and receiver devices 114, such as prompts for transaction request data. The generation module 220 may also be configured to generate transaction messages for payment transactions and data messages for blockchain transactions for the processing thereof as discussed herein. The generation module 220 may be further configured to generate intermediate addresses, such as by generating controlled payment numbers or digital tokens, as applicable.

The processing server 102 may also include a transaction processing module 222. The transaction processing module 222 may be configured to perform functions associated with the processing of transactions as part of the processing server 102 as discussed herein. For example, the transaction processing module 222 may be configured to initiate payment transactions for fiat currency transactions, some of which may utilize multiple currencies, such as by submitting a properly formatted transaction message to a payment network 116 via payment rails associated therewith. The transaction processing module 222 may also be configured to submit data for blockchain transactions to a node in the appropriate blockchain network.

The processing server 102 may also include a transmitting device 224. The transmitting device 224 may be configured to transmit data over one or more networks via one or more network protocols. In some instances, the transmitting device 224 may be configured to transmit data to sending institutions 108, receiving institutions 110, sender devices 112, receiver devices 114, payment networks 106, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to sending institutions 108 and receiving institutions 110, which may be superimposed or otherwise encoded with transaction messages, such as authorization requests, for payment transactions, requests for controlled payment numbers or digital tokens, or other data as discussed herein. The transmitting device 224 may be configured to electronically transmit data signals to sender devices 112 and receiver devices 114 that may be superimposed or otherwise encoded with prompts for transaction request data or notifications regarding processed payment transactions, blockchain transactions, and cross-currency transactions. The transmitting device 224 may also be configured to electronically transmit data signals to payment networks 116 and nodes in blockchain networks that may be superimposed or otherwise encoded with authorization requests and other transaction messages and data messages for the processing of payment transactions and blockchain transactions.

### Processing of Cross-Currency Transactions

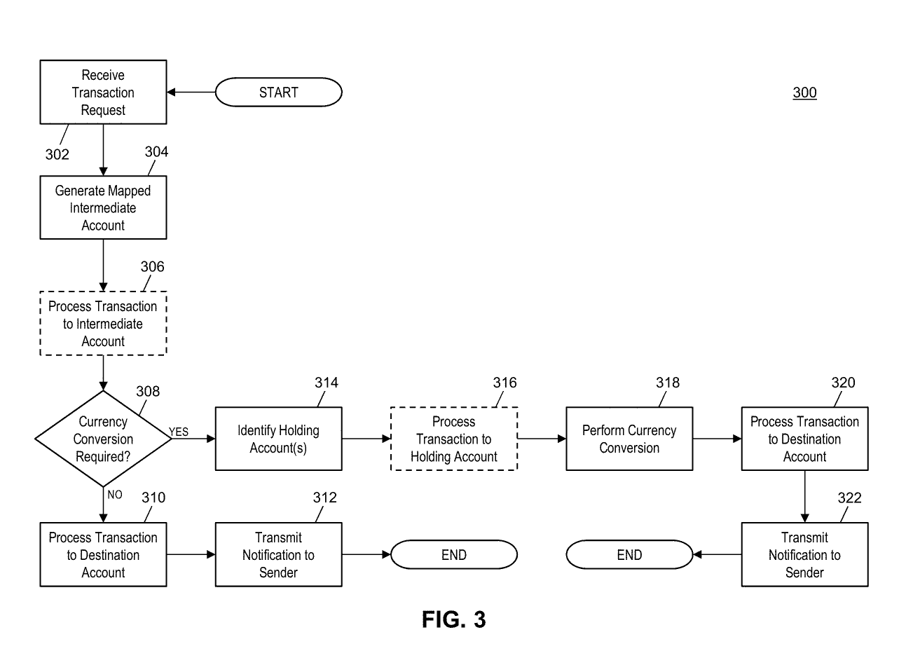

FIG. 3 illustrates an example process 300 executed by the processing server 102 of FIG. 2 in the system 100 of FIG. 1 for the processing of cross-currency transactions using intermediate transaction accounts.

In step 302, the receiving device 202 of the processing server 102 may receive a transaction request for a cross-currency transaction. The transaction request may include at least a source address, a destination address, a source currency, a destination currency, and at least one currency amount in either the source currency or the destination currency. In some cases, the transaction request data may be received from a single sender device 112. In other cases, a portion of the data may be separately received from a receiver device 114. In step 304, the generation module 220 of the processing server 102 may generate an intermediate address associated with an intermediate transaction account for use in the cross-currency transaction. In the process 300, the intermediate transaction account may utilize the source currency, and, in some cases, the intermediate address may be a controlled payment number or digital token issued on the intermediate transaction account. In some instances, the intermediate address may be mapped to the source transaction account associated with the source address and may be limited to a single transaction.

In step 306, the transaction processing module 222 of the processing server 102 may initiate a payment transaction or blockchain transaction, as applicable, for payment of an amount of the source currency (e.g., the currency amount included in the transaction request or a currency based thereon using a conversion from destination currency to source currency) from the transaction account associated with the source address to the transaction account associated with the intermediate address. In embodiments where the intermediate address may be mapped to the source transaction account, step 306 may be skipped.

In step 308, the processing server 102 may determine if conversion of the currency is required for the transaction. If no conversion is required (e.g., both the source currency and the destination currency are the same, or are of such currencies and the immediate and destination transaction accounts capable of cross-border transactions), then, in step 310, the transaction processing module 222 of the processing server 102 may initiate a payment transaction for payment of the currency amount (e.g., or an amount based thereon if the currency amount is in the source currency) of the destination currency from the intermediate transaction account to a transaction account associated with the destination address. Initiation of the payment transaction may include the generation (e.g., by the generation module 220) of a transaction message and submission thereto (e.g., by the transmitting device 224) to a payment network 116 for processing using traditional methods and systems. In step 312, the transmitting device 224 of the processing server 102 may electronically transmit a notification message to the sender device 112 to inform the sender 104 that the transaction was processed successfully.

If, in step 308, the processing server 102 determines that a conversion is required, then, in step 314, the processing server 102 may identify (e.g., via execution of a query on the memory 210 thereof by the querying module 218 thereof) at least a holding transaction account that is issued in the destination currency to be used to fund the transfer to the destination transaction account. In cases where the intermediate address is mapped to the source transaction account, a holding transaction account issued in the source currency may also be identified. In such cases, the process 300 may proceed to step 316 where the transaction processing module 222 may process a payment transaction (e.g., or blockchain transaction, as applicable) for payment of the appropriate amount of source currency from the source transaction account to the holding transaction account issued in the source currency. In some embodiments, step 316 may be processed as step 306.

In step 318, the transaction processing module 222 of the processing server 102 may perform a conversion of the source currency to the destination currency to identify the proper currency amount for the transfer of funds into the destination transaction account, if applicable. In some cases, the conversion may utilize a conversion rate provided in the transaction request. In other cases, other sources may be used for the conversion rate, such as internal storage (e.g., in the memory 210), the sending institution 108, destination institution 110, one or more currency exchanges, or other suitable source. In step 320, the transaction processing module 220 of the processing server 102 may initiate a payment transaction (e.g., or blockchain transaction, as applicable) for payment of the proper amount of destination currency from the holding account issued in the destination currency to the transaction account associated with the destination address. Initiation of the payment transaction may include the generation (e.g., by the generation module 220) of a transaction message and submission thereto (e.g., by the transmitting device 224) to a payment network 116 (e.g., or node in the associated blockchain network, as applicable) for processing using traditional methods and systems. In step 322, the transmitting device 222 of the processing server 102 may electronically transmit a notification to the sender device 112 to inform the sender 104 of the successful processing of the cross-currency transaction.

### Exemplary Method for Tokenized Cross-Currency Transacting

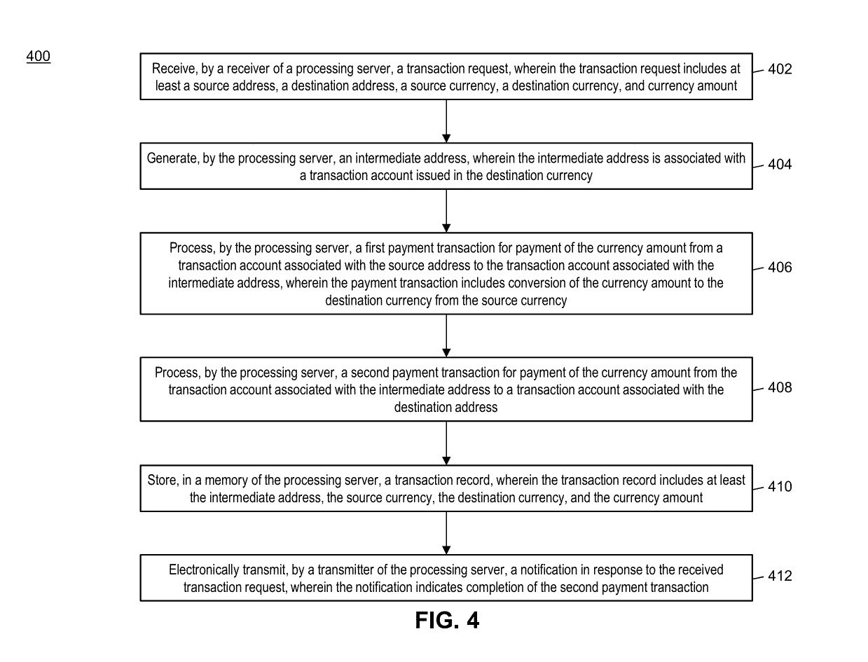

FIG. 4 illustrates a method 400 for the processing of a cross-currency transaction by a centralized processor utilizing an intermediate transaction account.

In step 402, a transaction request may be received by a receiver (e.g., the receiving device 202) of a processing server (e.g., the processing server 102), wherein the transaction request includes at least a source address, a destination address, a source currency, a destination currency, and currency amount. In step 404, an intermediate address may be generated by the processing server (e.g., via the generation module 220 thereof), wherein the intermediate address is associated with a transaction account issued in one of: the source currency and the destination currency. In step 406, a first payment transaction may be processed by the processing server (e.g., via the transaction processing module 222 thereof) for payment of the currency amount from a transaction account associated with the source address to the transaction account associated with the intermediate address, wherein the payment transaction includes conversion of the currency amount to the destination currency from the source currency if the intermediate address is associated with a transaction account issued in the destination currency.

In step 408, a second payment transaction may be processed by the processing server (e.g., via the transaction processing module 222 thereof) for payment of the currency amount from the transaction account associated with the intermediate address to a transaction account associated with the destination address, wherein the payment transaction includes conversion of the currency amount to the destination currency from the source currency if the intermediate address is associated with a transaction account issued in the source currency. In step 410, a transaction record may be stored in a memory (e.g., the memory 210) of the processing server, wherein the transaction record includes at least the intermediate address, the source currency, the destination currency, and the currency amount. In step 412, a notification may be electronically transmitted by a transmitter (e.g., the transmitting device 224) of the processing server in response to the received transaction request, wherein the notification indicates completion of the second payment transaction.

In one embodiment, at least one of the source currency and the destination currency may be a crypto-currency. In some embodiments, the source currency may be a first crypto-currency and the destination currency may be a second crypto-currency. In one embodiment, the intermediate address may be a blockchain address associated with a blockchain currency and generation of the intermediate address comprises generating a cryptographic key pair comprised of a public key and private key and generating the intermediate address using the public key. In a further embodiment, the method 400 may further include generating, by the processing device, a digital signature using the private key, wherein processing the second payment transaction includes submitting a blockchain transaction to a node in a blockchain network, wherein the submission includes at least the destination address, the currency amount, and the digital signature. In some embodiments, the immediate address may be a one-time use transaction account number. In one embodiment, the intermediate address may be a digital token. In some embodiments, generating the intermediate address may include identifying, in the transaction request, a supplied address as the intermediate address.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for tokenized cross-currency transacting. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for tokenized cross-currency transacting, comprising:
receiving, by a receiver of a processing server, a transaction request, wherein the transaction request includes at least a source address, a destination address, a source currency, a destination currency, and currency amount;
generating, by the processing server, an intermediate address, wherein the intermediate address is associated with a transaction account issued in one of: the source currency and the destination currency;
processing, by the processing server, a first payment transaction for payment of the currency amount from a transaction account associated with the source address to the transaction account associated with the intermediate address, wherein the payment transaction includes conversion of the currency amount to the destination currency from the source currency if the intermediate address is associated with a transaction account issued in the destination currency;
processing, by the processing server, a second payment transaction for payment of the currency amount from the transaction account associated with the intermediate address to a transaction account associated with the destination address, wherein the payment transaction includes conversion of the currency amount to the destination currency from the source currency if the intermediate address is associated with a transaction account issued in the source currency;
storing, in a memory of the processing server, a transaction record, wherein the transaction record includes at least the intermediate address, the source currency, the destination currency, and the currency amount; and
electronically transmitting, by a transmitter of the processing server, a notification in response to the received transaction request, wherein the notification indicates completion of the second payment transaction.

2. The method of claim 1, wherein at least one of the source currency and the destination currency is a crypto-currency.

3. The method of claim 1, wherein the source currency is a first crypto-currency and the destination currency is a second crypto-currency.

4. The method of claim 1, wherein the intermediate address is a blockchain address associated with a blockchain currency and generation of the intermediate address comprises generating a cryptographic key pair comprised of a public key and private key and generating the intermediate address using the public key.

5. The method of claim 4, further comprising:
generating, by the processing device, a digital signature using the private key, wherein processing the second payment transaction includes submitting a blockchain transaction to a node in a blockchain network, wherein the submission includes at least the destination address, the currency amount, and the digital signature.

6. The method of claim 1, wherein the immediate address is a one-time use transaction account number.

7. The method of claim 1, wherein the intermediate address is a digital token.

8. The method of claim 1, wherein generating the intermediate address includes identifying, in the transaction request, a supplied address as the intermediate address.

9. A system for tokenized cross-currency transacting, comprising:
a receiver configured to receive a transaction request, wherein the transaction request includes at least a source address, a destination address, a source currency, a destination currency, and currency amount;
a processing server configured to
generate an intermediate address, wherein the intermediate address is associated with a transaction account issued in the destination currency,
process a first payment transaction for payment of the currency amount from a transaction account associated with the source address to the transaction account associated with the intermediate address, wherein the payment transaction includes conversion of the currency amount to the destination currency from the source currency if the intermediate address is associated with a transaction account issued in the destination currency, and
process a second payment transaction for payment of the currency amount from the transaction account associated with the intermediate address to a transaction account associated with the destination address, wherein the payment transaction includes conversion of the currency amount to the destination currency from the source currency if the intermediate address is associated with a transaction account issued in the source currency;
a memory of the processing server configured to store a transaction record, wherein the transaction record includes at least the intermediate address, the source currency, the destination currency, and the currency amount; and
a transmitter configured to electronically transmit a notification in response to the received transaction request, wherein the notification indicates completion of the second payment transaction.

10. The system of claim 9, wherein at least one of the source currency and the destination currency is a crypto-currency.

11. The system of claim 9, wherein the source currency is a first crypto-currency and the destination currency is a second crypto-currency.

12. The system of claim 9, wherein the intermediate address is a blockchain address associated with a blockchain currency and generation of the intermediate address comprises generating a cryptographic key pair comprised of a public key and private key and generating the intermediate address using the public key.

13. The system of claim 9, wherein
the processing device is further configured to generate a digital signature using the private key, and
processing the second payment transaction includes submitting a blockchain transaction to a node in a blockchain network, wherein the submission includes at least the destination address, the currency amount, and the digital signature.

14. The system of claim 9, wherein the immediate address is a one-time use transaction account number.

15. The system of claim 9, wherein the intermediate address is a digital token.

16. The system of claim 9, wherein generating the intermediate address includes identifying, in the transaction request, a supplied address as the intermediate address.
